(19) United States
(12) Patent Application Publication
(10) Pub. No.: US 2008/0037416 A1
(43) Pub. Date: Feb. 14, 2008

(54) Portable terminal and method for multitasking

(75) Inventors: Moon-Sang Jeong, Daegu Metropolitan City (KR); Dong-Hwan Choi, Daegu Metropolitan City (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO.,LTD., Gyeonggi-do (KR)

(21) Appl. No.: 11/639,757

(22) Filed: Dec. 15, 2006

(30) Foreign Application Priority Data
Jun. 8, 2006 (KR) 10-2006-0051388

(51) Int. Cl. H04Q 7/00; H04H 1/00; H04N 7/20

(52) U.S. Cl. 370/212; 370/313; 725/62; 725/63

(57) ABSTRACT

Provided are a portable terminal and method for multitasking for executing application programs of the portable terminal together with reception of digital broadcasting. The multitasking method of the present invention includes receiving and reproducing digital broadcast data requested by a user, and providing multitasking of executing at least one application program of the portable terminal according to a user's request during the reception and reproduction of the digital broadcast data.

### PRIORITY

This application claims priority under 35 U.S.C. § 119 to an application entitled “Portable Terminal And Method For Multitasking” filed in the Korean Intellectual Property Office on Jun. 8, 2006 and assigned Serial No. 2006-0051388, the contents of which are incorporated herein by reference.

### BACKGROUND OF THE INVENTION

1. Field of the Invention

The present invention relates generally to a portable terminal, and in particular, to a portable terminal for multitasking during a digital multimedia broadcasting service and a method thereof.

2. Description of the Related Art

Generally, a mobile communication system provides various services such as a Short Message Service (SMS), Multimedia Message Service (MMS) and moving image mail service in addition to a basic service of voice communication. Mobile communication systems can now provide a digital broadcasting service. Conventional analog broadcasting systems are being replaced by digital broadcasting systems that can provide high quality videos, audios and data services to users.

Given the advances in digital broadcasting and mobile communication technologies, digital broadcasting services that can be received while in motion, particularly a Digital Multimedia Broadcasting (DMB) service using mobile terminals, have attracted much attention. In a DMB service, various multimedia signals including audio and video signals are digitally modulated and delivered to one of fixed, portable and in-vehicle receivers.

DMB services are based on Digital Audio Broadcasting (DAB) technologies for digital radios, and further include multimedia broadcasting concepts to additionally deliver moving images and information services such as weather, news and location services. DMB services are attracting attention as next generation broadcast services because they can provide Compact Disc (CD) or a Digital Versatile Disc (DVD)-like high quality audio and video broadcast data to users in motion through mobile portable terminals or in-vehicle receivers, Specifically, DMB services enable users, in motion, to receive various multimedia broadcast data of multiple channels through mobile portable terminals or in-vehicle terminals having an omni-directional receiving antenna.

As compared with existing broadcasting services, DMB services can be characterized by receiver mobility. DMB systems are divided by signal transmission mechanisms into terrestrial and satellite systems. DMB systems are compared with existing broadcasting systems and comparison results are summarized in Table 1 below.

As shown in Table 1 below, compared with existing broadcasting services, DMB services can be characterized by mobility and the small size of receivers. Broadcasting services are provided though ground stations in terrestrial DMB systems, and through artificial satellites in satellite DMB systems.

In a satellite DMB system, as a new broadcast medium, programs are transmitted from a DMB broadcast center to satellites, which then retransmit the programs to mobile DMB terminals in a wide coverage area of the satellites. Due to use of satellites, satellite DMB services are available in outdoor environments across a large area. Gap fillers or repeaters can be required to receive DMB signals and retransmit the received DMB signals in order to provide services to users in shadow areas, such as underground or indoor regions.

TABLE 1

| | Mobility | | |
|---|---|---|---|
| | Fixed | Mobile | Comparison |
| Transmission | existing | Terrestrial | Ground |
| mechanism | public | DMB | station |
| | broadcasting | | |
| | existing | Satellite | Artificial |
| | satellite | DMB | satellite |
| | broadcasting | | |
| Comparison | Middle to large | Very small | |
| | receiver | receiver | |

As shown in Table 1 herein, in a terrestrial DMB system, programs are transmitted through a frequency spectrum suitable for terrestrial propagation. Unlike the satellite DMB system, broadcast signals are transmitted through base stations, which are similar to those for mobile terminals, on the ground. A terrestrial DMB service is a multimedia service combining TV, audio and data broadcasting that is provided through terrestrial waves to users in motion. The configuration of a system providing such DMB services is described herein as follows.

FIG. 1 shows an example of a configuration of a digital broadcasting system providing general digital broadcasting services. As shown in FIG. 1, the digital broadcasting system includes a data broadcasting center 110, at least one satellite 120, at least one base station 130, and a plurality of mobile, portable and fixed receivers such as vehicle receivers 140, mobile terminals 150 and home receivers 160.

The data broadcasting center 110 compresses and modulates DMB signals representing audios, videos and data, and transmits the modulated DMB signals to corresponding satellites 120 or base stations 130. Each satellite 120 or base station 130 receiving the DMB signals from the data broadcasting center 110 amplifies the received DMB signals, and retransmits the amplified DMB signals at different frequencies to the receivers 140, 150 and 160.

Each receiver 140, 150 or 160 receives the DMB signals from the corresponding satellite 120 or base station 130, then demodulates and decompresses the received DMB signals to output uncompressed audios, videos and data.

Rapidly advancing digital broadcasting technologies have enabled users in fast motion to receive noise-free digital broadcast programs, and have demanded development of new added functions and services for greater user convenience. For example, there is increasing necessity for a method to execute additional functions of the portable terminal while reproducing the broadcast signal in portable terminals receiving and reproducing signals broadcast through the DMB service.

However, conventional portable terminals providing the DMB service cannot execute any additional functions while receiving broadcast signals through the DMB service and reproducing the broadcast signals. That is, any necessary additional functions should be executed in conventional DMB portable terminals after a DMB reception/reproduction mode has been terminated. Therefore, if a user wants to use other functions while viewing/listening to a DMB service, the user should terminate the reception and reproduction of the DMB service, and use the other functions. In addition, after the other functions are executed, the portable terminal should execute an initial procedure for the DMB reception and reproduction again for the user to view and listen to the DMB service.

Accordingly, multitasking is required that can provide the portable terminal for the DMB service with other additional functions while the DMB service is provided.

### SUMMARY OF THE INVENTION

The present invention has been made in view of the above problems, and an object of the present invention is to provide a multitasking function of a portable terminal for simultaneously providing various additional functions.

Another object of the present invention is to provide a portable terminal and method for multitasking that can execute various additional functions in the portable terminal receiving and reproducing digital multimedia broadcast data.

Still another object of the present invention is to provide a portable terminal and method for multitasking that can execute other additional functions of the portable terminal during reproduction of the DMB data in the portable terminal receiving and reproducing DMB data.

Yet still another object of the present invention is to provide a portable terminal and method for outputting DMB data as a background, if a multitasking function is provided together with a reproduction of DMB data in the portable terminal receiving and reproducing the data.

Still further, another object of the present invention is to provide a portable terminal and method for multitasking that can receive DMB data, reproduce the DMB data as a background and execute various application programs of the portable terminal while reproducing the DMB data as the background in the portable terminal, receiving and reproducing the DMB data.

According to an aspect of the present invention to achieve the above objects, there is provided a multitasking method of a portable terminal, which includes receiving and reproducing digital broadcast data requested by a user; and executing at least one application program provided in the portable terminal during the reception and reproduction of the digital broadcast data.

According to another aspect of the present invention to achieve the above objects, there is provided a multitasking method of a portable terminal, which includes receiving and reproducing DMB data requested by a user; processing the DMB data being received and reproduced as a background corresponding to a multitasking command inputted during reception and reproduction of the DMB data, executing application programs of the portable terminal corresponding to the multitasking command after processing the DMB data as the background; and providing the executed application programs of the portable terminal while maintaining reproduction of the DMB data as the background.

According to still another aspect of the present invention to achieve the above objects, there is provided a portable terminal for multitasking, which includes a multimedia module for receiving digital broadcast data from a broadcast center and transmitting the digital broadcast data; a key input unit for executing a key input for reception and reproduction of the digital broadcast data received by the multimedia module and a key input for a multitasking function of the portable terminal during the reception and reproduction of the digital broadcast data; a multitasking processing unit for processing at least one application program of the portable terminal corresponding to a user's request during the reproduction of the digital broadcast data received by the multimedia module; a memory unit for storing the digital broadcast data received by the multimedia module, and for storing application programs that are related to the multitasking for executing application programs for simultaneously providing a digital broadcasting service, the digital broadcast data and application programs of the portable terminal; and a control unit for controlling signal flows between the multimedia module, the key input unit, the multitasking processing unit and the memory unit.

### BRIEF DESCRIPTION OF THE DRAWINGS

The above and other objects, features and advantages of the present invention will be more apparent from the following detailed description in conjunction with the accompanying drawings, in which:

FIG. 1 is a schematic drawing illustrating an example of a configuration of a system for providing a general digital broadcasting service;

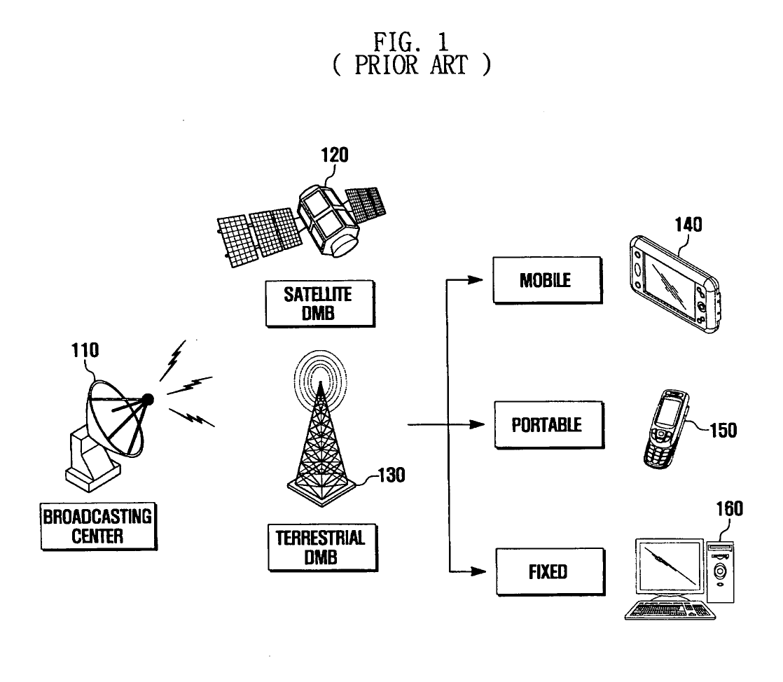

FIG. 2 is a block diagram illustrating a configuration of a portable terminal for executing a multitasking function according to the present invention;

FIG. 3 is a flow chart illustrating a method of multitasking operation in a portable terminal, according to the present invention; and

FIG. 4 is a flow chart illustrating a procedure of multitasking operation in a portable terminal, according to the present invention.

### DETAILED DESCRIPTION OF PREFERRED EMBODIMENTS

Hereinafter, preferred embodiments of the present invention are described in detail, herein, with reference to the accompanying drawings. Some constructions or processes known in the art may not be described to avoid obscuring the invention in unnecessary detail. Particular terms may be defined to describe the invention in the best manner. Accordingly, the meaning of specific terms or words used in the specification and the claims should not be limited to the literal or commonly employed sense, but should be construed in accordance with the spirit of the invention. The description of the various embodiments is to be construed as preferred only and does not describe every possible instance of the invention. Therefore, it should be understood that various changes may be made and equivalents may be substituted for elements of the invention.

Although a portable terminal providing a DMB service is used as an example of the portable terminal in the present invention for convenience of the description, the present invention is not limited thereto. That is, any portable terminal may be used as a portable terminal of the present invention. The present invention may be applied to any information/communication devices and multimedia devices such as portable terminals providing a DMB service, mobile phones, DMB receivers, wired/wireless phones, Personal Digital Assistants (PDAs), smart phones, IMT-2000 (International Mobile Telecommunication 2000) terminals, UMTS (Universal Mobile Telecommunication Service) terminals and DMB terminals.

The present invention relates to a method of receiving and reproducing digital broadcast data using a portable terminal that is receiving digital broadcasting in a digital broadcasting system. Particularly, a portable terminal according to the present invention provides multitasking that can process various application programs while receiving and reproducing DMB data.

In a portable terminal according to the present invention, if multitasking is provided together with DMB data reproduction, the DMB data can be output as a background.

Generally, various applications such as a call, Short Message Service (SMS), schedule management and games are supported in a portable terminal. Particularly, as digital devices are integrated and combined, the portable terminal has come to include a function of receiving and reproducing digital broadcast data like that of DMB. Application programs (e.g., a DMB player) are used for executing reception and reproduction of DMB data. For example, Electronic Program Guide (EPG) and channel information are received when a DMB player operates, and a portable terminal receives DMB data from a corresponding channel and displays the DMB data on a screen. In addition, a user can use various functions for control related to DMB data reproduction and channel change, using the DMB player. If the DMB player stops, reception and reproduction of the DMB data are terminated.

As described above, application programs such as schedule management, photographing and games may not be executed in conventional portable terminals while DMB data is received and reproduced using a DMB player. However, a portable terminal according to the present invention reproduces DMB data including video, audio and caption data as a background while DMB data is received and reproduced by multitasking. Various application programs provided in the portable terminal can be executed during the reproduction of the DMB data as the background, and thereby a user can use the portable terminal usefully.

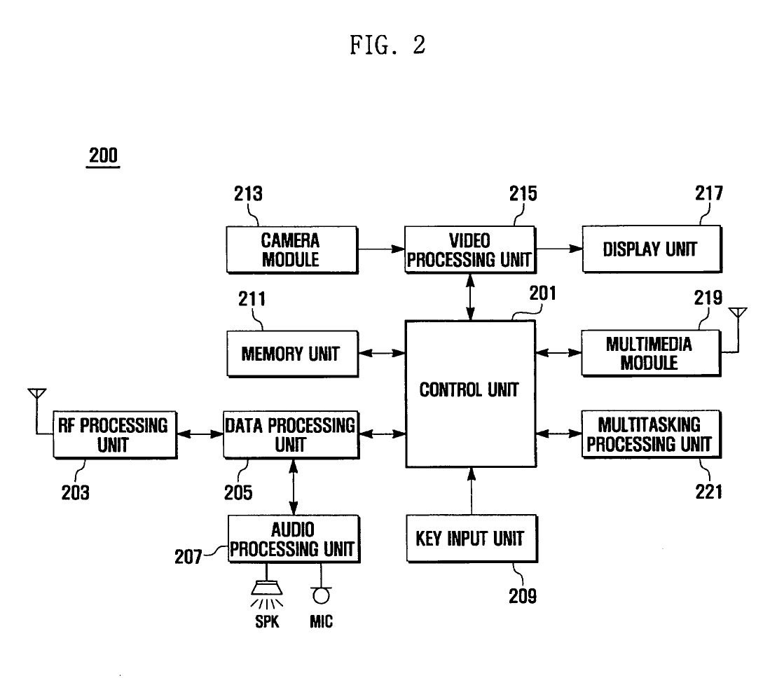

FIG. 2 is a block diagram illustrating a configuration of a portable terminal for executing a multitasking function according to the present invention. The portable terminal shown in FIG. 2 can process various application programs while receiving DMB data from a broadcast center and reproducing the DMB data.

The portable terminal 200 includes a control unit 201, a Radio Frequency (RF) processing unit 203, a data processing unit 205, an audio processing unit 207, a key input unit 209, a memory unit 211, a camera module 213, a video processing unit 215, a display unit 217, a multimedia module 219 and a multitasking processing unit 221.

Referring to FIG. 2, the portable terminal providing a DMB service includes an input means, a processing means, a storing means, an output means and a communication means. The input means can include the audio processing unit 207 for processing voice data input from a microphone, key input unit 209 for receiving numeric/character data input by a user, and a camera module 213 for receiving video data by photographing an object. The input means can further include the display unit 217, if a Liquid Crystal Display (LCD) device of the display unit 217 is configured as a touch screen type. That is, the input means having the above configuration inputs voice data, numeric/character data and video data.

The processing means includes the video processing unit 215 for processing digital data received from the camera module 213 and processing video data, related to a DMB service, received from the multimedia module 219; the data processing unit 205 for processing voice data received from the audio processing unit 207 or numeric/character data received from the key input unit 209; the control unit 201 for controlling operation of the portable terminal; the multimedia module 219 for receiving broadcast signals of a DMB service, separating the broadcast signals into video, audio and data signals, outputting the video, audio and data signals after decoding, and if a user requests additional functions through the input means, providing multimedia broadcast data of the DMB service; and the multitasking processing unit 221 for executing various application programs of the portable terminal corresponding to a user's request while the multimedia broadcast data received from the multimedia module 219 is reproduced. That is, the processing means processes user's data (e.g., voice data, character data and image data) input through the input means and additional functions requested by the user.

The storing means includes the memory unit 211, for storing data input received from the input means, data related to the DMB service received from the multimedia module 219, and multitasking application programs for simultaneously executing additional functions of the portable terminal (e.g., application programs for audio/video broadcasting service of the DMB service, and application programs for executing various application programs of the portable terminal together with broadcast data of the DMB service).

The output means includes the display unit 217 for displaying a screen corresponding to input or requested data and additional functions, and the audio processing unit 207 for outputting audio data. That is, the output means displays a screen corresponding to data from the input means and data stored in the storing means and data related to additional functions.

The communication means includes the RF processing unit 203 and at least one antenna. The communication means wirelessly transmits the user data to another user or exchanges data content by synchronizing with an external web server. The above components are described in more detail as follows.

The RF processing unit 203 operates for communications such as a portable phone communication, SMS, MMS and data communication. The RF processing unit 203 converts voice/sound and control data to RF signals and transmits the RF signals, and receives RF signals, converts the RF signals to voice/sound and control data and outputs the voice/sound and control data. Preferably, the RF processing unit 203 includes an RF transmitter for up-converting and amplifying RF signals to be transmitted, and an RF receiver for low-noise amplifying and down-converting received RF signals.

The data processing unit 205 can include an encoding/modulating means for signals to be transmitted to the RF processing unit 203, and a demodulating/decoding means for signals received from the RF processing unit 203. The audio processing unit 207 reproduces audio signals output from the data processing unit 205 or multimedia module 219, as well as transmits audio signals inputted from the microphone to the data processing unit 205. That is, the audio processing unit 207 converts voice/sound and audio data related to DMB to audible sound and outputs through a speaker, and outputs audio signals received from the microphone, under the control of the control unit 201.

The key input unit 209 includes a plurality of numeric, character and functional keys for inputting numeric and character information and setting various functions. That is, the key input unit 209 outputs key input signals to the control unit 201 to control operation related to reproduction and control of DMB data, such as reproduction and termination, channel change, volume adjustment and song selection. In addition, the key input unit 209 executes a key input for reception and reproduction of DMB data received by the multimedia module 219, and for a multitasking function of the portable terminal during reception and reproduction of the DMB data. The key input unit 209 executes key input for processing the DMB data as a background when a multitasking function is executed together with reproduction of the DMB data.

The memory unit 211 can include a program region and a data region. The program region can store a program for controlling general operation of the portable terminal, a program for providing a DMB service and a program related to a multitasking function for processing various application programs of the portable terminal during reproduction of broadcast data of the DMB service. In addition, the memory unit 211 stores a specific portion of DMB data according to a selection signal transmitted from the key input unit 209 or by a preset method, and data processed by other application programs of the portable terminal, while DMB data is reproduced.

Further, the memory unit 211 stores reproduction and control information for DMB data displayed by the display unit 217, and the EPG of the DMB. The reproduction and control information for DMB data includes channel numbers, channel titles and broadcast program titles. The data region stores data generated during execution of the programs, and setting information related to a DMB service and a multitasking function according to the present invention, as a database.

Programs related to the multitasking function according to the present invention can include a program for controlling reception and reproduction of DMB data corresponding to input information for using a DMB service; a program for providing audio/video information, channel information and broadcast data corresponding to input information for using the DMB service; a program for maintaining, if a multitasking request signal is input during reception and reproduction of the DMB data, the reception and reproduction of the DMB and for controlling execution of other programs corresponding to the request signal; a program for processing the DMB data as a background when a multitasking request signal is input; a program for updating and displaying reproduction status, channel information and progress status of the DMB data while other programs of the portable terminal are executed by a multitasking function; and a program for controlling switching between programs related to the DMB service for background processing of the DMB data and other programs of the portable terminal during multitasking. Preferably, the above programs can be stored in a flash file format.

The control unit 201 controls overall operation of the portable terminal. For example, the control unit 201 controls the flow of signals between components such as the multimedia module 219, data processing unit 205, key input unit 209, memory unit 211, video processing unit 215 and multitasking processing unit 221. In addition, if switching signals for the DMB service are input from the key input unit 209, the control unit 201 controls to set a mode corresponding to switching signals. For example, the control unit 201 controls switching between a phone mode for a mobile communication service and a multimedia mode for the DMB service, and setup thereof. In addition, the control unit 201 controls display of user data or additional functions generated or managed corresponding to input switching or setup signals. The control unit 201 controls maintenance of reception and reproduction of the DMB data to be processed as a background and execution of various programs of the portable terminal during background processing of the DMB data.

The camera module 213 receives image signals of objects, and converts the received image signals to digital signals by an encoder (not shown). The video processing unit 215 converts the digital signals from the camera module 213 to video signals and transmits the video signals to the display unit 217. The video processing unit 215 transmits broadcast data of the DMB service from the multimedia module 219 to the display unit 217 under the control of the control unit 201. The video processing unit 215 transmits data corresponding to program execution during DMB data display by a multitasking function to the display unit 219. The video processing unit 215 compresses and decompresses video data. The display unit 217 displays video data from the video processing unit 215 on a screen. In addition, the display unit 217 displays data of programs for providing a DMB service, video data of audio/video channels in the DMB service and caption data on the screen under the control of the control unit 201. The display unit 217 displays data corresponding to program execution performed by a multitasking function on the screen during reproduction of the DMB data received by the multimedia module 219. The display unit 217 displays information regarding DMB reproduction and control on a screen, and a selection menu for executing a multitasking function. The display unit 217 displays operation of various programs of the portable terminal during reproduction of DMB data as a background.

The multimedia module 219 identifies the type of DMB service requested by a user (e.g., satellite DMB and terrestrial DMB), and provides a broadcast service such as video, audio and caption corresponding to the identified DMB service. In addition, the multimedia module 219 transmits received DMB data to the video processing unit 215 and audio processing unit 207.

The multimedia module 219 receives DMB data transmitted from a broadcast center. The multimedia module 219 operates as a module for receiving satellite DMB broadcast if the DMB data is transmitted through a satellite DMB system, and operates as a module for receiving terrestrial DMB broadcast if the DMB data is transmitted through a terrestrial DMB system. That is, the multimedia module 219 can receive satellite or terrestrial DMB data.

The multimedia module 219 receives DMB data, separates video data and audio data from the received DMB data, decodes through a coder/decoder (codec) and transmits the decoded data to the control unit 201.

The multitasking processing unit 221 processes video data of the DMB data, audio data and caption data as a background corresponding to a command for reproducing DMB data as the background from the control unit 201. The multitasking processing unit 221 processes at least one application program of the portable terminal corresponding to a multitasking command during reproduction of the DMB data as the background.

Although the multimedia module 219 in FIG. 2 is described as a DMB receiving device in the present invention, the present invention is not limited thereto. That is, the multimedia module 219 can include functions supporting a multitasking function during reproduction of DMB data. For this end, the multimedia module 219 includes a tuner for receiving DMB data, and the multitasking processing unit 221. Preferably, a DMB processor executes the function of the multitasking processing unit 221.

If the multimedia module 219 executes the function of the multitasking processing unit 221, the multitasking processing unit 221 can be omitted in FIG. 2.

In the portable terminal having the above configuration, a multitasking method for executing various other programs of the portable terminal during reception and reproduction of DMB data is described as follows.

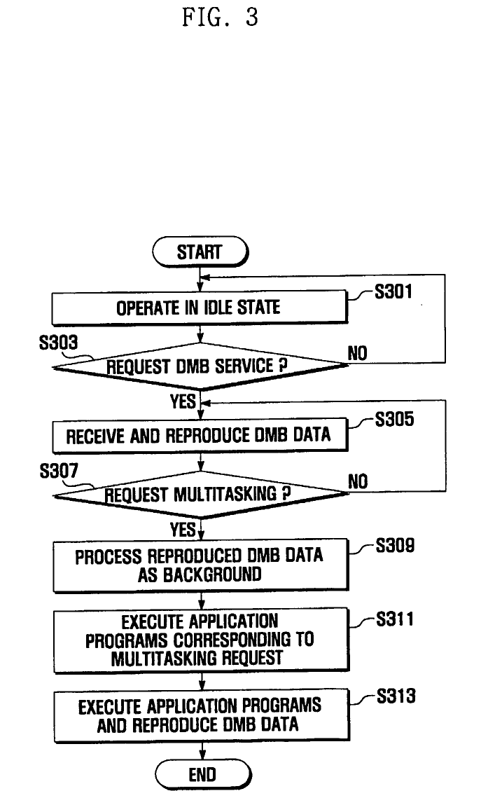

FIG. 3 is a flow chart illustrating a method of multitasking operation in a portable terminal, according to the present invention. Referring to FIG. 3, foremost, the portable terminal operates in an idle state in step S301. If a user requests a DMB service by, for example, a key input in step S303, the portable terminal receives DMB data from a broadcast center and reproduces the DMB data by executing application programs (e.g., DMB player) for providing the DMB service corresponding to the user request for the DMB service in step S305.

In step S307, if the user inputs a signal for requesting multitasking (for example, execution of other application programs of the portable terminal during reception and reproduction of the DMB data in step S305), in step S309, the portable terminal processes the reproduced DMB data as a background in response to the multitasking request signal. Video data, audio data and caption data of the DMB data are processed as the background individually or simultaneously.

In step S311, the portable terminal executes application programs of the portable terminal corresponding to the multitasking request signal The portable terminal executes other application programs corresponding to a user's request while maintaining reception and reproduction of the DMB data to process the DMB data as the background in step S313.

As described herein, application programs for executing reception and reproduction of the DMB data and other application programs of the portable terminal are provided in the portable terminal according to the present invention. Accordingly, a user can control execution of application programs of the portable terminal while viewing and listening to DMB. For example, a user can write a character message or play a game while listening to audio of the DMB, or make a phone call while viewing video or captions of the DMB. In addition, reception and reproduction of the DMB data are maintained as a background while writing a character message, and the DMB service can be viewed and listened to immediately after writing the character message.

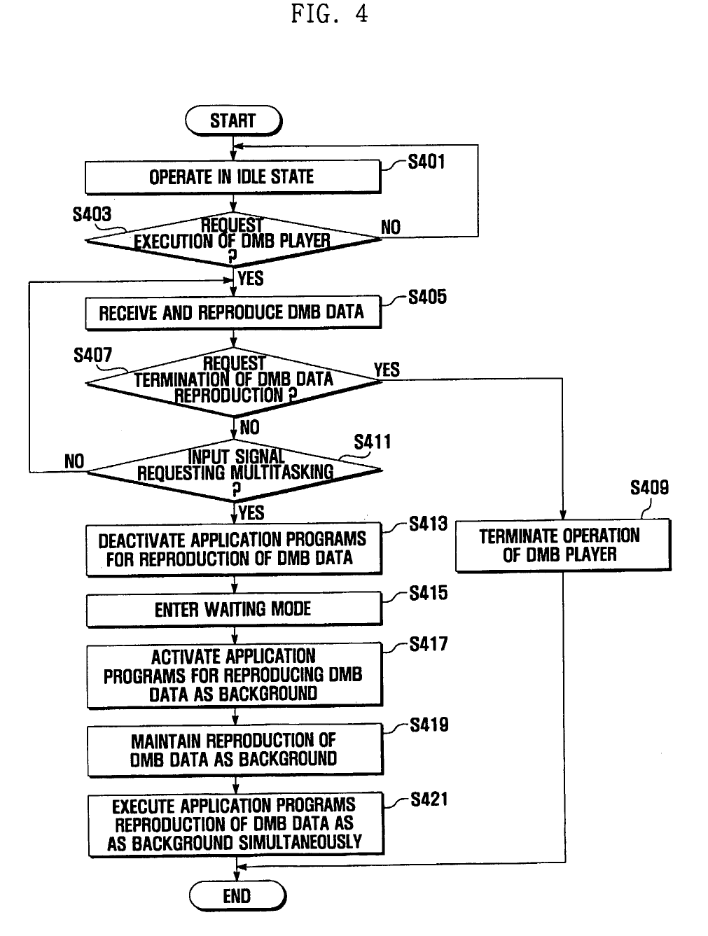

FIG. 4 is a flow chart illustrating a method of multitasking operation in a portable terminal, according to the present invention. The multitasking operation by application programs (e.g., a DMB player) for processing reception and reproduction of the DMB data and internal operation of the DMB player is described herein below.

Referring to FIG. 4, foremost, in step S401 the portable terminal operates in an idle state. In step S403, if a user inputs a signal to request execution of the DMB player for a DMB service the portable terminal operates the DMB player in response to the user's request signal to receive the DMB data from a broadcast center and reproduce the DMB data in step S405.

In step S407, if the user inputs a signal requesting termination of DMB data reproduction), the portable terminal terminates reception and reproduction of the DMB data by terminating operation of the DMB player in step S409. That is, the portable terminal terminates operations related to the DMB service such as reception, channel separation, decoding and reproduction of the DMB data.

If the user does not request termination of the DMB reproduction at step S407, and inputs a signal requesting multitasking in step S411, the portable terminal deactivates application programs in the DMB player for reproduction of DMB data in step S413, and the portable terminal enters a waiting mode in step S415. Next, the portable terminal activates application programs for reproducing the DMB data as a background in step S417, and in step S419 maintains reproduction of the DMB data as the background.

The portable terminal simultaneously processes the DMB data provided by the DMB player and additional functions corresponding to application programs of the portable terminal, by executing the application programs of the portable terminal requested by the user and simultaneously maintaining reproduction of the DMB data in step S421. For example, if a user inputs keys to connect a call while viewing and listening to the DMB, the portable terminal switches from a DMB mode to a phone mode and outputs video data of the DMB data as the background.

In addition, the portable terminal can execute tasks (e.g., audio task and video task) for reproduction of the DMB data as the background. The application programs of the portable terminal can control interfaces to transmit commands to control the DMB data reproduced as the background during multitasking.

As described above, the portable terminal and method for multitasking according to the present invention have an advantage that other additional functions of the portable terminal can be provided during reproduction of DMB data. That is, when a multitasking function is provided together with reproduction of the DMB data, the portable terminal outputs the DMB data as a background and simultaneously provides various additional functions of the portable terminal, thereby increasing user's convenience.

While the present invention has been shown and described with reference to certain preferred embodiments and accompanying drawings thereof, it will be understood by those skilled in the art that various changes or modifications in form and details may be made therein without departing from the spirit of the invention as defined by the appended claims.

What is claimed is:

1. A multitasking method of a portable terminal comprising:
receiving and reproducing digital broadcast data requested by a user; and
executing at least one application program provided in the portable terminal during the reception and reproduction of the digital broadcast data.

2. The multitasking method of claim 1, further comprising:
receiving input of a command for execution of application programs of the portable terminal during the reception and reproduction of the digital broadcast data;
processing the digital broadcast data, being received and reproduced, as a background corresponding to the command for execution of application programs; and
executing the application programs of the portable terminal according to the execution command after processing the digital broadcast data as a background.

3. The multitasking method of claim 1, further comprising:
reproducing, if a multitasking request signal is input during reception and reproduction of the digital broadcast data, the digital broadcast data as a background;
receiving input of a command for executing the application programs of the portable terminal from a user; and
executing application programs of the portable terminal corresponding to the input command while maintaining reproduction of the digital broadcast data as the background.

4. A multitasking method of a portable terminal comprising:
receiving and reproducing digital multimedia broadcasting (DMB) data requested by a user;
processing the DMB data, being received and reproduced, as a background corresponding to a multitasking command input during reception and reproduction of the DMB data,
executing application programs of the portable terminal corresponding to the multitasking command after processing the DMB data as the background; and
providing the executed application programs of the portable terminal while maintaining reproduction of the DMB data as the background.

5. The multitasking method of claim 4, wherein processing the DMB data, being received and reproduced, as a background comprises:
receiving input of the multitasking command during the reception and reproduction of the DMB data;
deactivating application programs for reproduction of the DMB data corresponding to the multitasking command; and
activating application programs for reproducing the DMB data as a background.

6. The multitasking method of claim 5, wherein the application programs of the portable terminal control interfaces to transmit commands for controlling the DMB data reproduced as the background during multitasking.

7. A portable terminal for multitasking comprising:
a multimedia module for receiving digital broadcast data from a broadcast center and transmitting the digital broadcast data;
a key input unit for executing a key input for reception and reproduction of the digital broadcast data received by the multimedia module and a key input for a multitasking function of the portable terminal during the reception and reproduction of the digital broadcast data;
a multitasking processing unit for processing at least one application program of the portable terminal corresponding to a user's request during the reproduction of the digital broadcast data received by the multimedia module;
a memory unit for storing the digital broadcast data received by the multimedia module, and for storing application programs that is related to the multitasking for executing application programs for providing a digital broadcasting service, the digital broadcast data and application programs of the portable terminal simultaneously; and
a control unit for controlling a flow of a signal between the multimedia module, key input unit, multitasking processing unit and memory unit.

8. The portable terminal for multitasking of claim 7, further comprising a display unit for displaying data executed according to the application programs and information regarding reproduction and control of the digital broadcast data during the reproduction of the digital broadcast data.

9. The portable terminal for multitasking of claim 7, wherein the memory unit stores at least one of:
a program for controlling the reception and reproduction of the digital broadcast data corresponding to input information for using a digital broadcasting service;
a program for maintaining, if a multitasking request signal is input during the reception and reproduction of the digital broadcast data, the reception and reproduction of the digital broadcast data and controlling execution of application programs of the portable terminal corresponding to the requested signal;
a program for controlling reproduction of the digital broadcast data as a background and maintenance of a reproduction state, when a multitasking request signal is input;
a program for updating and displaying the reproduction state of the digital broadcast data, channel information and progress status information during execution of the application programs of the portable terminal by multitasking; and
a program for controlling switching between application programs related to use of a digital broadcasting service and the application programs of the portable terminal.

10. The portable terminal for multitasking of claim 7, wherein the control unit controls maintenance of reception and reproduction of the digital broadcast data, and execution of other application programs of the portable terminal while maintaining the digital broadcast data.

11. The portable terminal for multitasking of claim 7, wherein the multitasking processing unit processes reproduction of the digital broadcast data received from the multimedia module as a background.

12. The portable terminal for multitasking of claim 7, wherein the multitasking processing unit executes at least one application programs of the portable terminal corresponding to a multitasking command while reproducing the digital broadcast data as a background.
